(19) United States
(12) Patent Application Publication
(10) Pub. No.: US 2006/0146442 A1
(43) Pub. Date: Jul. 6, 2006

(54) Method of fabricating a workpiece from a sheet of material

(76) Inventors: Song Cheh Ser, Singapore (SG); Weng How Leong, Singapore (SG)

Correspondence Address: COOPER & DUNHAM, LLP, 1185 AVENUE OF THE AMERICAS, NEW YORK, NY, 10036, US

(21) Appl. No.: 11/293,766

(22) Filed: Dec. 1, 2005

(30) Foreign Application Priority Data
Dec. 1, 2004 (SG) 200407252-6

(51) Int. Cl. G11B 17/00

(52) U.S. Cl. 360/97.01

(57) ABSTRACT

A method of fabricating a workpiece from a sheet of material to form an exterior right angle edge on the work piece. A sheet of material having a top surface and a bottom surface is provided. The top surface of the sheet of material is pressed with a die in which a contact surface of the die includes an interior right angle edge. The bottom surface of the sheet of material is pressed with a punch. The die and the punch force material from the sheet of material to flow into and fill a cavity defined by the contact surface of the die and the punch, so that the material in the cavity forms the exterior right angle edge of the workpiece. A hard disk drive base formed from a single sheet of material is provided. The hard disk base comprises a central segment having a top surface for supporting a spindle motor assembly of a hard disk drive, a first sidewall forming a right angle with the center segment, and a second sidewall forming a right angle with the center segment. The first and the second sidewalls are parallel to each other.

### TECHNICAL FIELD

The present invention relates to a method of fabricating a workpiece from a sheet of material. In particular, it relates to a method of fabricating the base for hard disk drives from a sheet of metal.

### BACKGROUND

A hard disk drive (HDD) is a mass data storage device commonly used in computers. The hard disk drive is comprised of a number of electronic and mechanical components, including a spindle motor assembly and a printed circuit board, which are mounted on a housing. The conventional housing includes a base and a top cover within which the electronic and mechanical components are mounted and enclosed. The base typically includes a metal framework having enough strength and rigidity to provide structural and functional support to these electronic and mechanical components.

In general, the bases of hard disk drives, such as 3.5 inch and 2.5 inch hard disk drives are fabricated in mass production by die-casting. In a die casting process, metal materials such as aluminum alloy are heated to a molten state. The molten material is injected into a die to form a hard disk base with necessary shapes and profiles. The base is then allowed to cool until it has solidified, and is then removed from the die.

Fabricating hard disk bases by die casting presents a number of problems. Firstly, since the metal material must be melted, high equipment and process costs are inevitable relative to processes carried out at room temperature. Secondly, it takes considerable amount of time for the die cast product to cool down from the molten state, for example over 600 degrees Celsius for aluminum alloy. Therefore, the production cycle time is much longer than desired. Further, hard disk drive bases made by die-casting require many subsequent treatment processes, such as trimming, deburring, stress relieving and coating. Such factors make die casting a hard drive base extremely expensive.

It is therefore desirable to provide a low cost and high productive solution for fabricating HDD bases so that to overcome the problems faced by die-casting.

### SUMMARY

In accordance with a first aspect of the present invention, there is provided a method of fabricating a workpiece from a sheet of material to form an exterior right angle edge on the work piece. A sheet of material having a top surface and a bottom surface is provided. The top surface of the sheet of material is pressed with a die in which a contact surface of the die includes an interior right angle edge. The bottom surface of the sheet of material is pressed with a punch. The die and the punch force material from the sheet of material to flow into and fill a cavity defined by the contact surface of the die and the punch, so that the material in the cavity forms the exterior right angle edge of the workpiece.

In one embodiment, a central segment and a side segment are formed by pressing the top and bottom surfaces of the sheet of material, the side segment intersects the central segment at the exterior right angle edge. In a further embodiment, the top surface forms a recess within the central segment, wherein the recess is to couple to a hard disk drive spindle motor. The side segment forms two or three sidewalls perpendicular to the central segment. The central segment, the recess and the sidewalls form a hard disk drive base. In an alternative embodiment, the recess is formed with a height to accommodate at least two media disks of the hard disk drive.

In accordance with a second aspect of the present invention, there is provided a hard disk drive base formed from a single sheet of material. The hard disk drive base comprises a central segment having a top surface for supporting a spindle motor assembly of a hard disk drive, a first sidewall forming a right angle with the center segment, and a second sidewall forming a right angle with the center segment. The first and the second sidewalls are parallel to each other.

In one embodiment, the hard disk drive base further comprises a first ridge coupled between the central segment and the first sidewall, and a second coupled between the central segment and the second sidewall. The first ridge and the second ridge are to couple to a hard disk drive cover.

In a further embodiment, the central segment has a recess to couple to a hard disk drive spindle motor. In an alternative embodiment, the recess has a height to accommodate at least two media disks of the hard disk drive.

### BRIEF DESCRIPTION OF THE DRAWINGS

These and other aspects and advantages of the present invention will be described in detail with reference to the accompanying drawings, in which:

FIG. 1 is a perspective view of a sheet metal stock for fabricating a HDD base according to one embodiment of the present invention;

FIGS. 2A to 2G are partial cross sectional views showing a process of fabricating a hard disk drive base using a sheet metal stock of FIG. 1;

FIG. 3A is a perspective view showing a sheet metal stock for fabricating a HDD base made after the step shown in FIG. 2B;

FIG. 3B is a cross sectional view showing sheet metal stock for fabricating a HDD base having a second sidewall formed thereon;

FIG. 4A is a perspective view showing a hard disk drive base having two sidewalls formed according to one embodiment of the present invention;

FIG. 4B is a partially enlarged cross sectional view of FIG. 4A along A-A;

FIG. 4C is a perspective view showing a hard disk drive base having three sidewalls formed according to one embodiment of the present invention;

FIG. 5 is a perspective view showing a hard disk drive base formed according to one embodiment of the present invention having flat surface clearances formed for receiving a top cover;

FIGS. 6A to 6E and 6G are partial cross sectional views showing a process of fabricating a hard disk drive base according to another embodiment of the present invention;

FIG. 6F is a partially enlarged view of FIG. 6E;

FIG. 6H is a partially enlarged view of FIG. 6G;

FIG. 7 is a perspective view showing a hard disk drive base formed according to the embodiment shown in FIGS. 6A-6H.

### DETAILED DESCRIPTION OF THE PREFERED EMBODIMENTS

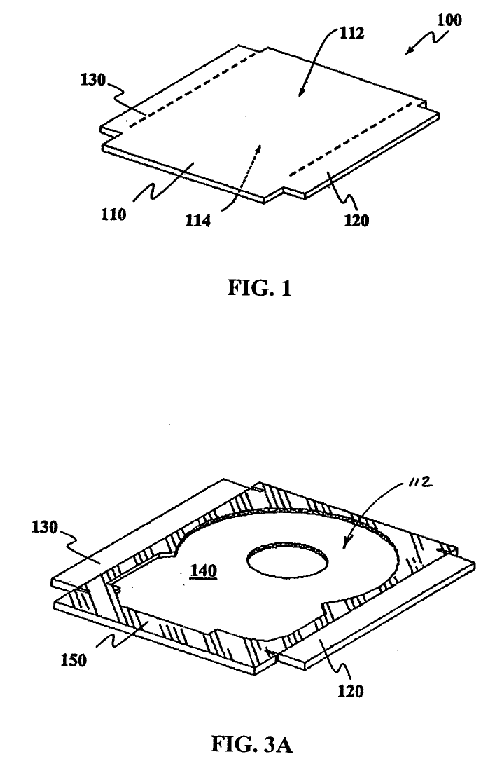

As shown in FIG. 1, a sheet of material 100 is provided for fabricating a HDD base according to the present invention. By way of example, sheet of material 100 may be a sheet metal stock, such as an aluminum alloy sheet having a thickness of about 1 millimeter (mm) to about 3 mm. Sheet metal stock 100 has a center segment 110, a first side segment 120 adjacent to one side of center segment 110 and a second side segment 130 adjacent to another side of center segment 110. Center segment 110 also has a bottom surface 114 opposite to a top surface 112.

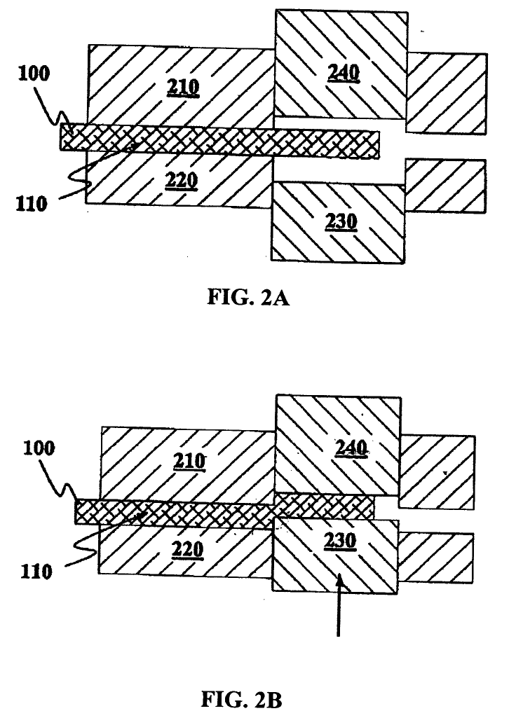

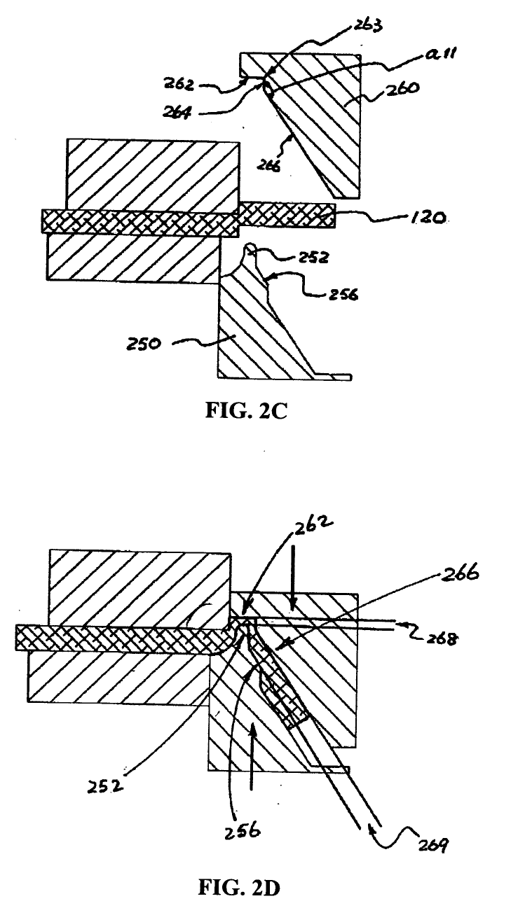

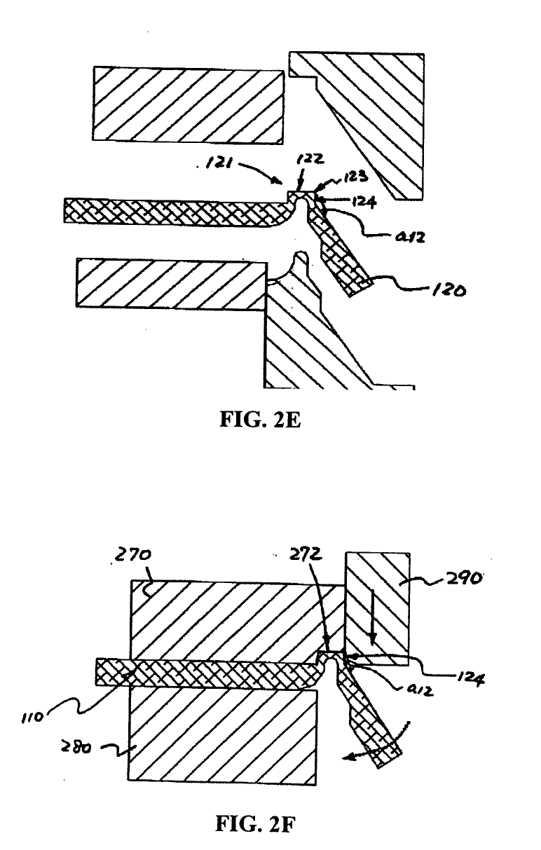

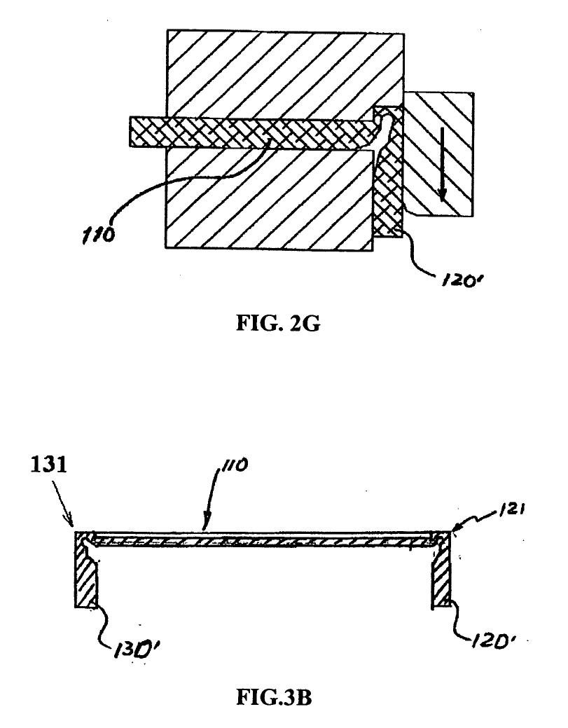

To fabricate the hard disk drive base, sheet metal stock 100 is placed between a first upper die 210 and a first lower die 220, with center segment 110 held between first upper and lower dies 210 and 220, as shown in FIG. 2A. A first punch 230 is moved towards a first pad 240 to press and to deform sheet metal stock 100 to form a recess 140 at top surface 112, as shown in FIG. 2B and FIG. 3A. Recess 140 is to support a spindle motor assembly and an actuator motor assembly of a HDD (not shown) and generally has a depth of about 1.5 mm. Between recess 140, first and second side segment 120 and 130 is a periphery area 150.

FIGS. 2C, 2D, and 2E illustrate a second punch 250 that is moved to press first side segment 120 against a second pad 260. Second pad 260 has a first contact surface 262, a second contact surface 264 and a third contact surface 266. First and second contact surfaces 262 and 264 form an interior right angle edge 263. Third contact surface 266 extends from second contact surface 264 with an included angle all. In one embodiment of the present invention, the width of first contact surface 262 is about 2 mm, the height of second contact surface 264 is about 1 mm, and included angle all is about 150 degrees. Second punch 250 should also have a tip 252 of width less than the width of second contact surface 262 and a slope 256 parallel to third contact surface 266 of second pad 260.

When second punch 250 and second pad 260 are moved towards a closed position, a first cavity 268 is formed between tip 252 and first contact surface 262 and a second cavity 269 is formed between slope 256 and third contact surface 266, as shown in FIG. 2D. In this embodiment, first cavity 268 and second cavity 269 are narrower than the thickness of sheet metal stock 100.

When moved to the closed position, the material between second punch 250 and second pad 260 is forced to flow into and fill the cavity defined by first contact surface 262, second contact surface 264 and tip 252. As a result, the material forced into the cavity forms a ridge 121 at one end of first side segment 120. Ridge 121 includes a first end surface 122 and a second end surface 124. First and second end surface 122 and 124 form an exterior right angle edge 123, as shown in FIG. 2E. Pressed between slope 256 and third surface 266, first side segment 120 extends from ridge 121 with an included angle a12 which is the same as included angle a11.

A third upper die 270, third lower die 280 and third punch 290 are then provided as shown in FIG. 2F. Third upper die 270 and third lower die 280 hold center segment 110 so that ridge 121 fills into an indentation corner 272 of third upper die 270. Third punch 290 then slides down to engage second end surface 124 such that movement and/or deformation of ridge 121 are prevented. Third punch 290 slides down further to force first side segment 120 to rotate towards third lower die 280, increasing angle a12. Third punch 290 moves until the included angle a12 is 180 degrees to form a first sidewall 120′, as shown in FIG. 2G. A similar process can be applied to deform second side segment 130 to form a second sidewall 130′ and a ridge 131, as shown in FIG. 3B.

In one embodiment of the present invention, ridges 121 and 131 may be used to couple to a hard disk drive cover, in which case, strict standards must be met. In particular, the width of ridge 121 is about at least 2 mm and the flatness of first end surface 122 ranges from about 10 microns to about 20 microns. Meeting these specifications allows ridge 121 to provide a air tight seal to a hard disk drive cover, thus protecting the interior of the hard disk drive from airborne particles that may harm the disk drive.

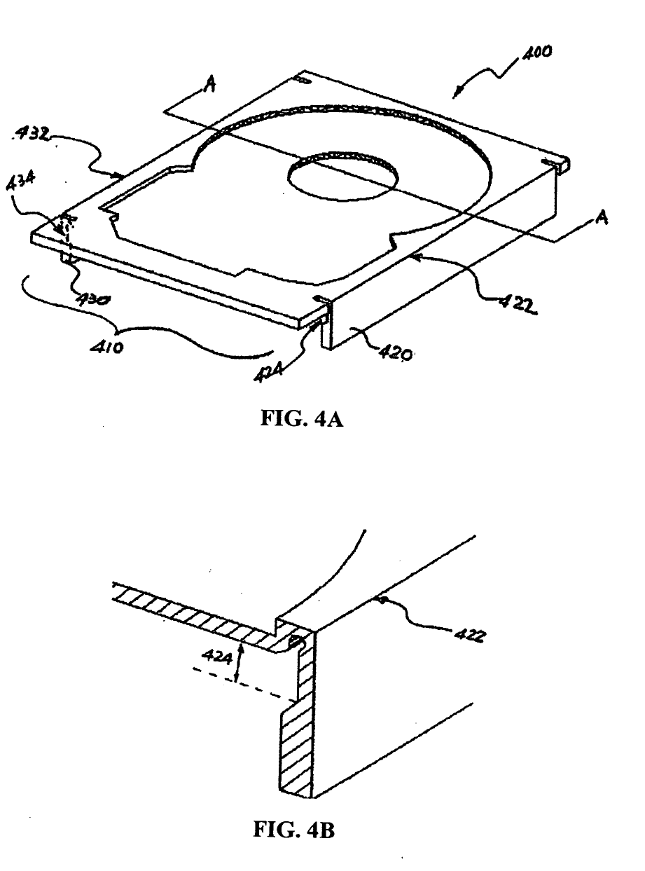

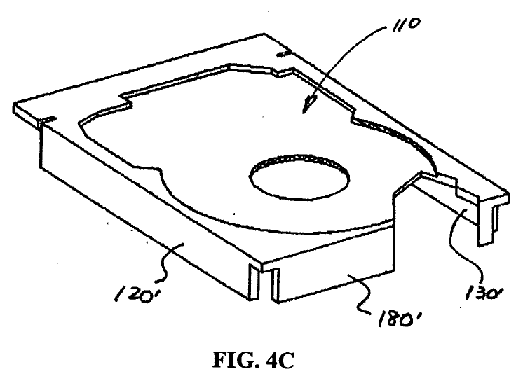

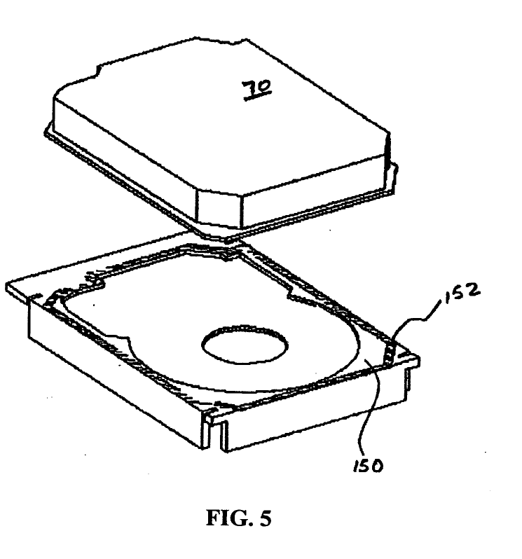

FIG. 4A shows a HDD base 400 fabricated according to one embodiment of the present invention. FIG. 4B is a partially enlarged cross sectional view of FIG. 4A along A-A. The base 400 has a center segment 410, a first sidewall 420 and a second sidewall 430 both extending from center segment 410, with first and second exterior right angle edges 422 and 432 formed between center segment 410 and first sidewall 420 and between center segment 410 and second sidewall 430, respectively. Base 400 is fabricated by deforming a single piece of sheet metal stock according to one embodiment of the present invention. Each sidewall has a material supply segment 424 and 434 adjacent to corresponding exterior right angle edges 422 and 432 (only segment 424 and exterior right angle ridge 422 are shown in FIG. 4B for ease of illustration). Segments 424 and 434 are less thick than the sheet metal stock 100.

According to another embodiment of the present invention, a third sidewall 180′ may also be formed along a third side of center segment 110 and perpendicular to first and second sidewalls 120′ and 130′, as shown in FIG. 4C. A HDD base having three sidewalls has increased strength and rigidity properties relative to a HDD base having only two sidewalls.

It should be appreciated, with reference to FIG. 5, that since the two or three sidewalls are formed with sharp exterior right angle edges surrounding the center segment, a flat periphery area 150 is obtained having clearances sufficient to fulfill HDD design requirements. A base fabricated according to the above provides an effective flat sealing area 152 at periphery area 150 for receiving a top cover 70.

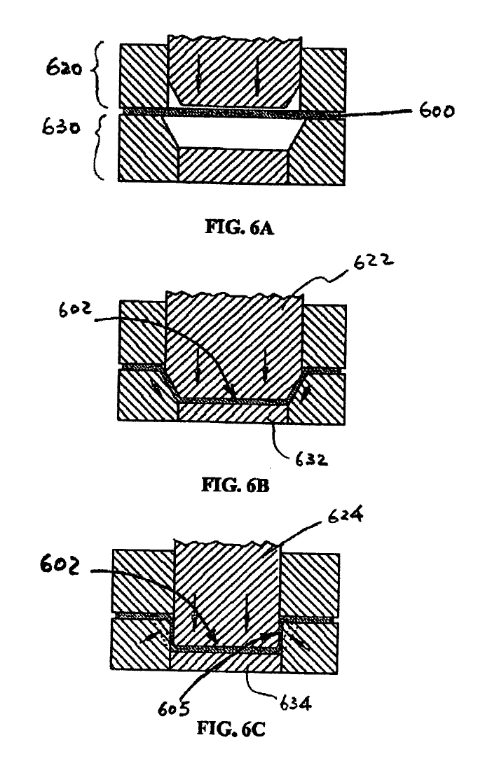

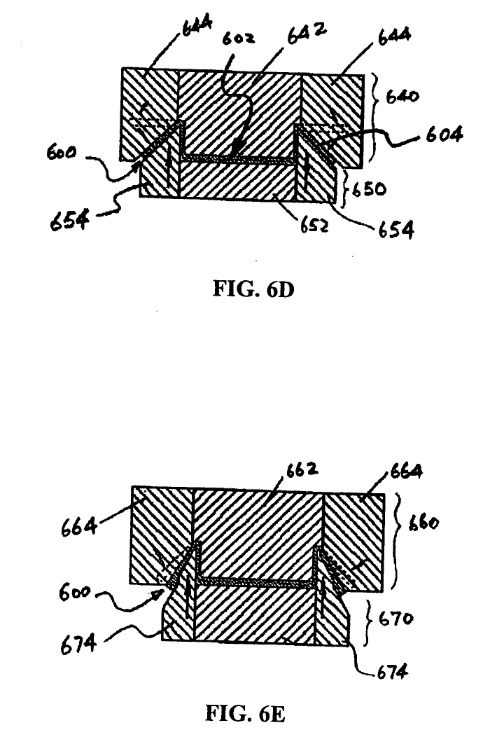

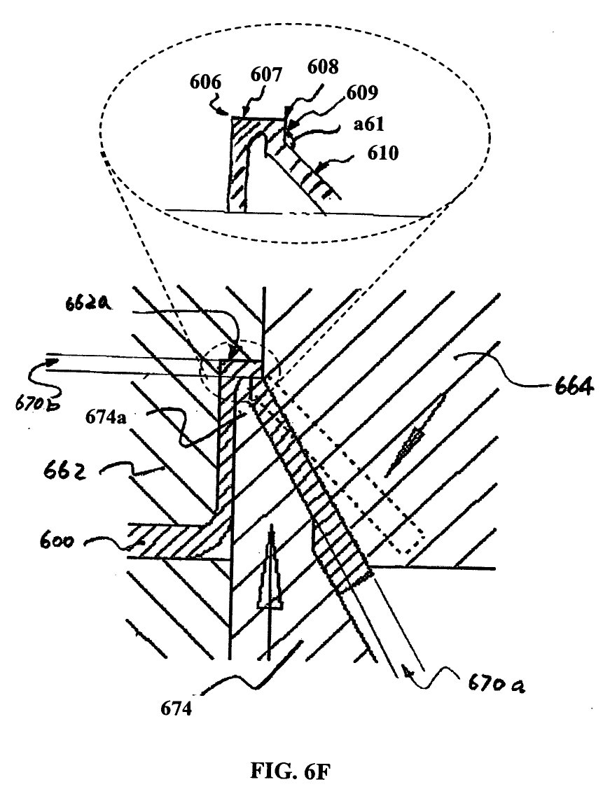

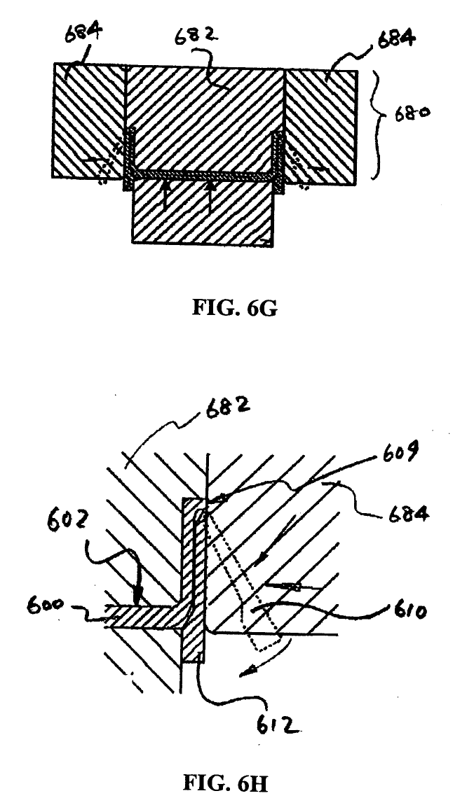

FIGS. 6A to 6H are partial cross sectional views showing a process of fabricating a hard disk drive base according to another embodiment of the present invention. As shown in FIGS. 6A and 6B, a sheet metal stock 600 is placed between upper and lower dies 620 and 630 for processing. Upper die 620 has a first punch 622 which presses sheet metal stock 600 against first pad 632 to form a recess 602, firstly with a sloped recess wall as shown in FIG. 6B.

Subsequently, a second punch 624 further presses the sloped recess against a second pad 634 so that to form a straight recess wall 605, as shown in FIG. 6C. During pressing, materials at the sidewall segment are under tension force exerted by second punch 624. As a result, the thickness of the sidewall segment is reduced from the original thickness of sheet metal stock 600. In this embodiment, the thickness of the sidewall segment is reduced to about half of the thickness of sheet metal stock 600.

In a next step as shown in FIG. 6D, the sheet metal stock 600 having a recess 602 formed thereon is placed between upper and lower dies 640 and 650. Upper pad 642 and lower pad 652 hold sheet metal stock 600 in place by pressing recess 602. Lower die 650 has a third punch 654 which presses sheet metal stock 600 against upper pads 642 and 644 such that periphery portion 604 of sheet metal stock 600 is bent in an angled manner.

In a further step as shown in FIGS. 6E and 6F, a fourth punch 674 presses sheet metal stock 600 with an acute end 674a, against upper pads 662 and 664. When moved towards a closed position, fourth punch 674 and upper pad 664 form a first gap 670a. At the same time, acute end 674a and an end surface 662a form a second gap 670b. Both the first and the second gaps 670a and 670b have a width less than the thickness of sheet metal stock 600. Therefore, fourth punch 674 forces material from sheet metal stock 600 to flow into and fill the cavity defined by first and second gaps 670a and 670b.

As a result, exterior right angle edges 606 and 608, a flat end 607 between exterior right angle edges 606 and 608, a first section 609 and a second section 610 on sheet metal stock 600 are formed. First section 609 is a side surface perpendicular to flat end 607 and intersects flat end 607 at exterior right angle edge 608. Second section 610 extends outwardly from first section 609 and forms an included angle a61.

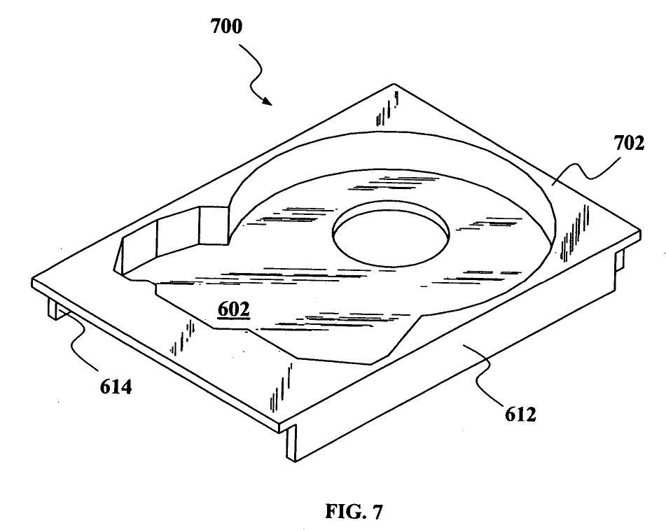

In a next step as shown in FIGS. 6G and 6H, a fifth punch 684 slides down by firstly holding first section 609 within upper pad 682 hence to prevent movement and deformation of first section 609, and further presses against second section 610 to cause second section 610 to rotate with respect to first section 609. Fifth punch 684 eventually straightens second section 610 to form a first sidewall 612 at one side of recess 602. Likewise, a second sidewall 614 is formed at an opposite of recess 602, as shown in FIG. 7.

A hard disk drive base 700 formed according to the embodiment illustrated in conjunction with FIGS. 6A-6H is shown in FIG. 7. Sidewalls 612 and 614 are formed at respective sides of recess 602, and both perpendicular to top surface 702. Recess 602, sidewalls 612 and 614 and top surface 702 form a hard disk drive base in which, recess 602 is to receive a spindle motor assembly (not shown) having two or more media disks (not shown) mounted thereon. Recess 602 will generally have a depth ranging from about 8 mm to about 15 mm. Sidewalls 612 and 614 form an external dimension in compliance with hard disk drive design standards for fixing the hard disk drive into a chassis of a computer or the like.

In view of the foregoing, it should also be appreciated that by the successful application of sheet metal stamping technology, a new and advantageous method of fabricating HDD base is developed by the present invention through which, many of the problems of fabricating HDD base by die casting, e.g. low production output, high equipment and process cost, etc., are successfully overcome.

As the present invention provides a new method of processing sheet metal to form an exterior right angle edge, it should be understood to be applicable to products and applications other than hard disk drives. Although embodiments of the present invention have been illustrated in conjunction with the accompanying drawings and described in the foregoing detailed description, it should be appreciated that the invention is not limited to the embodiments disclosed, and is capable of numerous rearrangements, modifications, alternatives and substitutions without departing from the spirit of the invention as set forth and recited by the following claims.

1. A method of fabricating a workpiece from a sheet of material to form an exterior right angle edge on the workpiece, comprising:
providing the sheet of material having a top surface and a bottom surface;
pressing the top surface with a contact surface of a die, wherein the contact surface includes an interior right angle edge; and
pressing the bottom surface with a punch, wherein the punch and the die are to force material from the sheet of material to flow into and fill a cavity defined by the contact surface of the die and the punch to form the exterior right angle edge.

2. The method as recited in claim 1 wherein pressing the top surface and pressing the bottom surface form a center segment and a side segment of the workpiece, wherein the side segment couples to the center segment at the exterior right angle edge.

3. The method as recited in claim 2 wherein the punch and the die compress a material supply segment of the side segment to force material from the side segment to flow into and fill the cavity.

4. The method as recited in claim 2, wherein pressing the top surface and pressing the bottom surface forms a ridge coupled between the center segment and the side segment.

5. The method as recited in claim 3, wherein the sheet of material has a thickness of about 1 mm to about 3 mm.

6. The method as recited in claim 5, wherein the material supply segment is pressed to a thickness of about half of the thickness of the sheet of material.

7. The method as recited in claim 4, wherein the ridge has a flatness of about 10 microns to about 20 microns.

8. The method as recited in claim 7, wherein the ridge is to couple to a hard disk drive cover.

9. The method as recited in claim 8, wherein the ridge has a width of at least about 2 mm.

10. A hard disk drive base, wherein the base is formed from a single sheet of material, comprising:
a center segment having a top surface for supporting a spindle motor assembly of a hard disk drive;
a first sidewall forming a right angle with the center segment; and
a second sidewall forming a right angle with the center segment, wherein the second sidewall is parallel to the first sidewall.

11. The hard disk drive base as recited in claim 10, further comprising:
a first ridge coupled between the center segment and the first sidewall; and
a second ridge coupled between the center segment and the second sidewall.

12. The hard disk drive base as recited in claim 11, further comprising a third sidewall forming a right angle to the center segment, wherein the third sidewall is perpendicular to the first sidewall and the second sidewall.

13. The hard disk drive base as recited in claim 12, further comprising a third ridge coupled between the center segment and the third sidewall.

14. The hard disk drive base as recited in claim 11, wherein the first ridge and the second ridge are to couple to a hard disk drive cover.

15. The hard disk drive base as recited in claim 14, wherein the width of the first ridge and the width of the second ridge is at least about 2 mm.

16. The hard disk drive base as recited in claim 15, wherein the first ridge and the second ridge have a flatness ranging from about 10 microns to about 20 microns.

17. The hard disk drive base as recited in claim 11, wherein the hard disk drive base is formed by metal stamping.

18. The hard disk drive base as recited in claim 17, wherein the first ridge and the second ridge have a height of about 1.5 mm.

19. The hard disk drive base as recited in claim 17, wherein the first ridge and the second ridge have a height ranging from about 8 mm to about 13 mm.

20. A method of fabricating a hard disk drive base from a single sheet of material, comprising:
pressing a top surface of the sheet of material with a contact surface of a die, wherein the contact surface includes an interior right angle edge; and
pressing a bottom surface of the sheet of material with a punch, wherein the punch and the die are to force material from the sheet of material to flow into and fill a cavity defined by the contact surface of the die and the punch to form an exterior right angle edge.

21. The method as recited in claim 20 wherein pressing the top surface and pressing the bottom surface form a center segment having a ridge coupled to a side segment at an exterior right angle edge.

22. The method as recited in claim 21, wherein the ridge is to couple to a hard disk drive top cover.

23. The method as recited in claim 22, wherein the ridge has a flatness ranging from about 10 microns to about 20 microns.

24. The method as recited in claim 23, further comprising stamping the top surface to define a recess within the center segment, wherein the recess is to support to a hard disk drive spindle motor.

25. The method as recited in claim 24, wherein the recess has a depth of about 1.5 mm.

26. The method as recited in claim 24, wherein the recess has a depth ranging from about 8 mm to about 13 mm.
